(19) United States
(12) Patent Application Publication
(10) Pub. No.: US 2026/0148598 A1
(43) Pub. Date: May 28, 2026

(54) METHOD AND SYSTEM FOR UNLOCKING A SMART LOCK IN AN EMERGENCY

(71) Applicant: RESIDEO LLC, Golden Valley, MN (US)

(72) Inventors: Qing Zhang, Shanghai (CN); Bin Shi, Shanghai (CN); Jun Wu, Shanghai (CN)

(73) Assignee: RESIDEO LLC, Golden Valley, MN (US)

(21) Appl. No.: 19/121,308

(22) PCT Filed: Oct. 17, 2022
(86) PCT No.: PCT/US2022/046888

§ 371 Date: Apr. 15, 2025

(51) Int. Cl. G07C 9/00

(52) U.S. Cl. CPC G07C 9/00309; G07C 9/00571; G07C 2009/0042; G07C 2209/08

(57) ABSTRACT

A safety and security system for monitoring a premise, comprising: a remote server communicatively coupleable to one or more user devices; one or more emergency triggering mechanisms installed in the premise for responding to emergency events; a smart door lock for locking and unlocking a door of the premise, wherein the smart door lock is unlockable by inputting a passcode to the smart door lock; and a control panel communicatively coupled to each of the one or more emergency triggering mechanisms, the 2024/085858 smart door lock and the remote server; wherein the safety and security system is configured to: generate, by the one or more emergency triggering mechanisms, at least one emergency signal in response to an emergency event; transmit, by the one or more emergency triggering mechanisms, the at least one emergency signal to the control panel; generate, by the control panel, a temporary passcode to temporarily unlock the smart door lock so as to open the door of the premise upon receiving the at least one emergency signal from the one or more emergency triggering mechanisms; transmit, by the control panel, the temporary passcode and the at least one emergency signal to the remote server such that the temporary passcode is obtainable by a human operator; transmit, by the control panel, the temporary passcode to the smart door lock; and enable, by the control panel or the smart door lock, the temporary passcode such that the smart door lock is unlockable by the temporary passcode in a predefined period of time.

### TECHNICAL FIELD

The present invention generally relates to a method and system for temporarily unlocking a smart lock in an emergency situation, and in particular their implementations in safety and security systems.

### BACKGROUND

An electronic lock is a locking device that operates by means of electric current and thus obviates the need for a traditional physical key. Among various types of electronic locks, electromagnetic locks and motor-operated locks are the two types that are more commonly used. Such electronic locks use either electro-magnets or electric motors to actuate the lock which is triggered by either supplying or removing electrical power to the locking mechanism.

Electronic locks can be unlocked or deactivated by authentication. Different authentication methods have been implemented in traditional electronic locks. For example, some traditional electronic locks may comprise a keypad through which a passcode (or PIN (personal identification number)) can be entered. In such as case, authentication is granted only where the input passcode matches the reference passcode stored in the lock. Some traditional electronic locks may rely on programmed key fobs or access cards (e.g., through RFID (radio-frequency identification), or NFC (near field communication)) that must be swiped or scanned to grant authentication and allow access. Others may use biometrics such as fingerprint or retinal scanning or voice print identification in order to authenticate users and control the locking device. Such biometrics based electronic locks provide a higher level of security and controlled access.

In recent years, new electronic lock varieties (also known as smart locks) that are enabled by smart technology have emerged and attracted a growing interest from both manufacturers and consumers. While the locking mechanism of a smart lock works in the same or a similar way as that of a traditional electronic lock, smart technology enabled features do provide some additional functionality over the traditional electronic locks. For example, some “smart” features may allow a smart lock to be remotely monitored and controlled by a smart device (e.g., a smart phone) or a remote controller in a wireless manner. Other “smart” features may allow a smart lock to be programmed such that it automatically locks and unlocks at certain predefined time instances.

Smart locks are often connected with other electronic devices (e.g., sensors, controllers, WiFi gateways) to form a smart system such as for example a safety and security system used for monitoring a premise. Existing smart systems comprising smart locks suffer from the problem that in response to an emergency event, smart locks cannot be unlocked in a timely and secure manner, thereby resulting in the rescue being delayed, and/or the premise being damaged, and/or the security of the premise being compromised.

Objects and aspects of the present claimed invention seek to alleviate at least these problems with the prior art.

### SUMMARY

According to a first aspect of the present invention, there is provided a safety and security system for monitoring a premise, comprising: a remote server communicatively coupleable to one or more user devices; one or more emergency triggering mechanisms installed in the premise for responding to emergency events; a smart door lock for locking and unlocking a door of the premise, wherein the smart door lock is unlockable by inputting a passcode to the smart door lock; and a control panel communicatively coupled to each of the one or more emergency triggering mechanisms, the smart door lock and the remote server; wherein the safety and security system is configured to: generate, by the one or more emergency triggering mechanisms, at least one emergency signal in response to an emergency event; transmit, by the one or more emergency triggering mechanisms, the at least one emergency signal to the control panel; generate, by the control panel, a temporary passcode to temporarily unlock the smart door lock so as to open the door of the premise upon receiving the at least one emergency signal from the one or more emergency triggering mechanisms; transmit, by the control panel, the temporary passcode and the at least one emergency signal to the remote server such that the temporary passcode is obtainable by a human operator; transmit, by the control panel, the temporary passcode to the smart door lock; and enable, by the control panel or the smart door lock, the temporary passcode such that the smart door lock is unlockable by the temporary passcode in a predefined period of time.

In an embodiment, the one or more emergency triggering mechanisms comprise at least one emergency button each actuatable by a user in the premise in response to a medical emergency.

In an embodiment, in response to any of the at least one emergency button being actuated, the actuated emergency button is operable to generate and transmit the at least one emergency signal.

In an embodiment, in response to a fire, the one or more emergency triggering mechanisms comprise at least one fire sensor each configured to generate and transmit the at least one emergency signal.

In an embodiment, the predefined period of time for the temporary passcode is less than 1 hour.

In an embodiment, the safety and security system is further configured to disable the temporary passcode upon expiry of the predefined period of time.

In an embodiment, the safety and security system is further configured to verify, by the remote server, whether the at least one emergency signal is true or false.

In an embodiment, the safety and security system is further configured to disable the temporary passcode when the at least one emergency signal is false.

In an embodiment, the safety and security system is further configured to unlock remotely, by the remote server, the smart door lock via a data network.

In an embodiment, the safety and security system further comprises one or more user devices, wherein the safety and security system is configured to relay, by the remote server, the temporary passcode and the emergency signal to one or more user devices via a data network.

According to a second aspect of the present invention, there is provided a method of operating a safety and security system for monitoring a premise, the safety and security system comprising: a remote server communicatively coupleable to one or more user devices; one or more emergency triggering mechanisms installed in the premise for responding to emergency events; a smart door lock for locking and unlocking a door of the premise, wherein the smart door lock is unlockable by inputting a passcode the smart door lock; and a control panel communicatively coupled to each of the one or more emergency triggering mechanisms, the smart door lock and the remote server; the method comprising: generating, by the one or more emergency triggering mechanisms, at least one emergency signal in response to an emergency event; transmitting, by the one or more emergency triggering mechanisms, the at least one emergency signal to the control panel; generating, by the control panel, a temporary passcode for temporarily unlocking the smart door lock so as to open the door of and gain access to the premise upon receiving the at least one emergency signal from the one or more emergency triggering mechanisms; transmitting, by the control panel, the temporary passcode and the at least one emergency signal to the remote server such that the temporary passcode is obtainable by a human operator; transmitting, by the control panel, the temporary passcode to the smart door lock; and enabling, by the control panel or the smart door lock, the temporary passcode such that the smart door lock is unlockable by the temporary passcode in a predefined period of time.

In an embodiment, the method further comprises disabling, by the control panel or the smart door lock, the temporary passcode upon expiry of the predefined period of time.

In an embodiment, the method further comprises verifying, by the remote server, whether the emergency event is true or false.

In an embodiment, the method further comprises disabling, by the control panel or the smart door lock, the temporary passcode when the emergency event is a false event.

In an embodiment, the method further comprises relaying, by the remote server, the temporary passcode and the emergency signal received from the control panel to one or more user devices via a data network.

Other aspects of the invention comprise a security system comprising the electronic device of the second aspect.

### BRIEF DESCRIPTION OF THE DRAWINGS

Embodiments of the present invention will now be described by way of example only and with reference to the accompanying drawings, in which:

FIG. 1 depicts schematically a functional block diagram of a safety and security system in accordance with an embodiment;

FIG. 2 shows an example use case of the safety and security system shown in FIG. 1 in an emergency; and

FIG. 3 shows a flow diagram of the method of operating a safety and security system (e.g., as shown in FIG. 1) in an emergency in accordance with an embodiment.

### DETAILED DESCRIPTION OF EMBODIMENTS

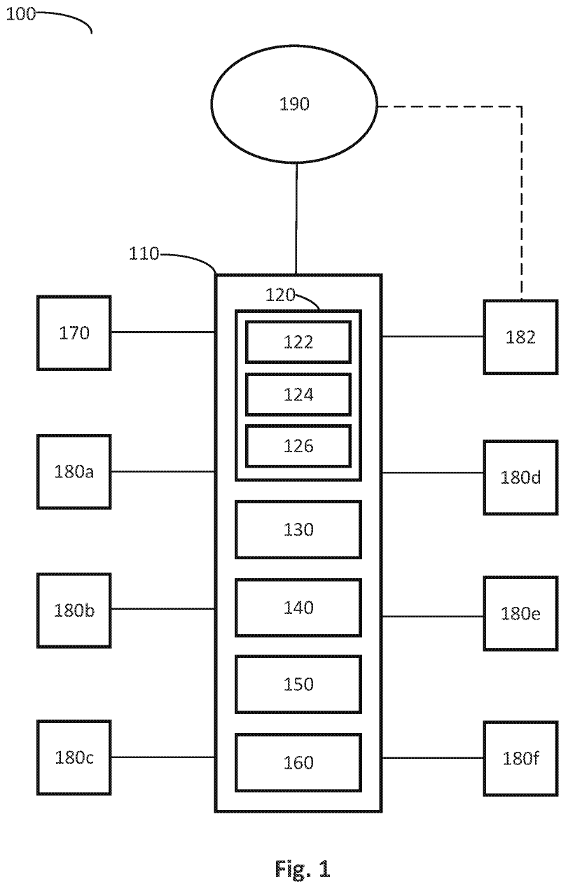

FIGS. 1 to 3 are related to embodiments of a safety and security system for monitoring a premise. The safety and security system may comprise: a remote server communicatively coupleable to one or more user devices; one or more emergency triggering mechanisms installed in the premise for responding to emergency events; a smart door lock for locking and unlocking a door of the premise, wherein the smart door lock is unlockable by inputting a passcode to the smart door lock; and a control panel communicatively coupled to each of the one or more emergency triggering mechanisms, the smart door lock and the remote server. The safety and security system may be configured to: generate, by the one or more emergency triggering mechanisms, at least one emergency signal in response to an emergency event; transmit, by the one or more emergency triggering mechanisms, the at least one emergency signal to the control panel; generate, by the control panel, a temporary passcode to temporarily unlock the smart door lock so as to open the door of the premise upon receiving the at least one emergency signal from the one or more emergency triggering mechanisms; transmit, by the control panel, the temporary passcode and the at least one emergency signal to the remote server such that the temporary passcode is obtainable by a human operator; transmit, by the control panel, the temporary passcode to the smart door lock; and enable, by the control panel or the smart door lock, the temporary passcode such that the smart door lock is unlockable by the temporary passcode in a predefined period of time.

With reference to FIG. 1, the safety and security system 100 comprises a control panel 110, one or more emergency triggering mechanisms 180a-180f, a siren 170, and a smart door lock 182. The control panel 110 may be communicatively coupled to the components (e.g., the emergency triggering mechanisms 180a-180f, the siren 170 and the smart door lock 182) of the safety and security system 100 via a wired or wireless path. In an embodiment, the control panel 110 may be communicatively coupled to a remote server 190 (e.g., a central control center) via a data network (e.g., the internet) in a wired or wireless manner. In some cases, the remote server 190 may act as a central control center responsible for monitoring and controlling a plurality of safety and security systems 100 in a certain area.

The one or more emergency triggering mechanisms 180a-180f may comprise one or more sensors commonly used in a home or business security system, which may include, for example, one or more motion sensors 180a for detecting when a person enters a room, one or more fire sensors 180b for indicating that a fire has been detected, one or more window 180c and door 180d sensors for indicating that a window or door has been opened, one or more shock sensors 180e for detecting a shock that occurs when a burglar strikes the door or window with a hard object, and/or one or more emergency indicators 180f. The one or more emergency indicators 180f may be each actuatable by a user in the premise in response to a medical emergency. Alternatively or in addition, the emergency indicators 180f may be for example a set of sensors configured to detect that a user is lying on the floor motionless for more than a threshold period of time.

The smart door lock 182 may be used to secure a main door of a premise at which the safety and security system 100 is installed. The smart door lock 182 may be any kind of electronic lock that is suitable for locking and unlocking a door and is remotely controllable. The smart door lock 182 may be remotely controllable by the control panel 110 through a certain wireless protocol. For example, in some cases, the smart door lock 182 and the control panel 110 may each comprise a Wi-Fi module configured to enable wireless communication through a Wi-Fi protocol. In some cases, the smart door lock 182 and the control panel 110 may each comprise a Zigbee module configured to enable wireless communication through the Zigbee wireless protocol. In other cases, the smart door lock 182 and the control panel 110 may each comprise a Z-wave module configured to enable wireless communication through the Z-Wave wireless protocol. Other ways of enabling a wireless communication are possible.

In case of a Wi-Fi smart door lock, the remote server 190 may establish a direct communication with the smart door lock 182 as well as the control panel 110. As such, the remote server 190 may impose a direct control over the smart door lock 182 e.g., to lock or unlock. In case of either Zigbee smart door lock 182 or Z-wave smart door lock 182, the remote server 190 may establish a direct communication with the control panel 110 and may indirectly control the smart door lock 182 through the control panel 110.

The smart door lock 182 may comprise a user interface (not shown) that enables interaction between a human user and the smart door lock 182. The user interface of the smart door lock 182 may comprise for example a keypad either with physical buttons or with a touch screen configured for a user to input a passcode. Additionally or alternatively, the user interface of the smart door lock 182 may comprise a means configured for biometrics based authentication. Additionally or alternatively, the user interface of the smart door lock 182 may be configured to allow a smart phone to control the smart door lock 182.

The control panel 110 may be configured to receive, process and transmit signals. To provide such functionalities, the control panel 110 may comprise a processing unit 130 (e.g., a microprocessor) for processing information (e.g., signals received from the components or devices of the security system 100 and the remote server 190 where available), a memory unit 140 (e.g., non-transient memory) for storing data (e.g., system information and control programs), a power unit 150 for powering the components of the control panel 110, and a communication unit 160 (e.g., a transceiver) for receiving signals from and transmitting signals to the components or devices of the security system 100 and the remote server 190 where available.

The control panel 110 may further be configured to provide a user interface between the human user and the security system 100. As can be seen in FIG. 1, the user interfacing functionalities may be provided by an integrated user interface unit 120 comprised in the control panel 110. In an embodiment, the user interface unit 120 may comprise an image sensor 122 (e.g., a digital camera), an electronic visual display 124 (e.g., a LCD backlit by LEDs) and a key pad 126. The user interface unit 120 may be used to arm and disarm the security system 100. The image sensor 122 may be used to capture images of the user whenever the user tries to change a setting of the control panel 110, e.g., to arm and disarm the security system 100. Each image may be formed by a plurality of image pixels and may be used for example to verify whether the user is authorized to make such a change. In addition, the image sensor 122 may be configured to monitor an ambient environment of the control panel 110.

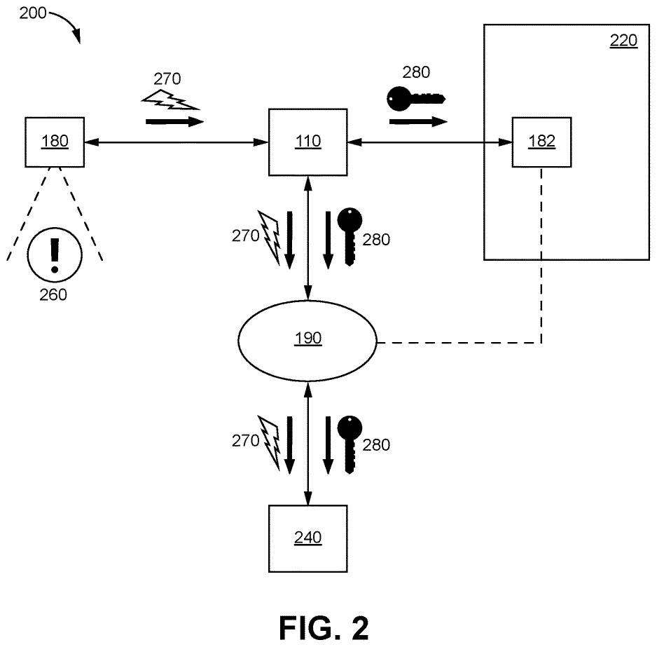

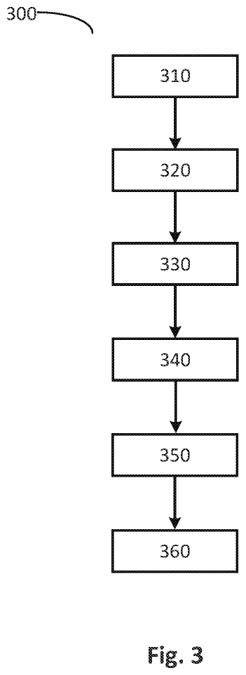

With reference to FIGS. 2 and 3, in an embodiment, the safety and security system 100 may be configured to perform for example the following six steps:

Step 310: the one or more emergency triggering mechanisms 180 a-180f (denoted 180 in FIG. 2) may generate at least one emergency signal 270 in response to an emergency event 260. The emergency event may be for example a burglary, a fire, a medical emergency, or a combination thereof. In response to a burglary, the at least one emergency signal 270 may be generated for example by a motion sensor 180a and/or a shock sensor 180e. In response to a fire, the at least one emergency signal may be generated for example by a fire sensor 180b. In response to a medical emergency, the at least one emergency signal 270 may be generated for example by an emergency indicator 180f having been actuated by a user (e.g., a person having a medical emergency).

Step 320: the one or more emergency triggering mechanisms 180a-180f may transmit the at least one emergency signal 270 to the control panel 110. Each of the one or more emergency triggering mechanisms 180a-180f may be connected to the control panel 110 either in a wired manner, or in a wireless (e.g., Bluetooth, WiFi) manner, or the combination thereof. Each of the one or more emergency triggering mechanisms 180a-180f may be configured to transmit the generated emergency signal 270 to the control panel 110.

Step 330: upon receiving the emergency signals 270 from the one or more emergency triggering mechanisms 180a-180f, the control panel 110 may generate a temporary passcode 280 for temporarily unlocking the smart door lock 182 so as to open the door 220 of the premise. In an embodiment, the control panel 110 may further comprise a passcode generator (not shown in the figures) configured to generate a temporary passcode 280. Upon receiving an emergency signal 270 from any emergency triggering mechanism 180a-180f, the processing unit 130 may command the passcode generator to generate a temporary passcode 280. Depending on the type and configuration of the smart door lock 182, a passcode 280 may comprise a string of characters including digits, and/or letters, and/or other symbols. Each passcode 280 may be randomly generated by the passcode generator.

Step 340: the control panel 110 may transmit the temporary passcode 280 that has been generated at step 330 and the at least one emergency signal 270 that has been received at step 320 to the remote server 190 such that the temporary passcode 280 is obtainable by a human operator. In an embodiment, the remote server 190 may act as a central control center responsible for monitoring and controlling a plurality of safety and security systems 100 in the area within which the premise is located. Upon receiving the temporary passcode 280 from the control panel 110, the central control center may give a warning signal so as to attract attention from the human operator. The human operator may then follow a certain emergency protocol and take actions accordingly (e.g. instruct the emergency services to visit the premises). The data communication between the control panel 110 and the remote server 190 may be established via a data network (e.g., the Internet).

Step 350: the control panel 110 may transmit the temporary passcode 280 (e.g., as indicated by the key sign in FIG. 2) to the smart door lock 182. Depending on the type of the smart door lock 182, the data communication between the control panel 110 and the smart door lock 182 may be established based on WiFi, Zigbee, Zwave or other wireless protocol.

Step 360: After the temporary passcode 280 has been received by the smart door lock 182, the control panel 110 or the smart door lock 182 itself may enable the temporary passcode 280 such that the smart door lock 182 is unlockable by the temporary passcode 280 in a predefined period of time. The passcode enablement allows the pre-existing passcode to be temporarily replaced by the temporary passcode 280. In an embodiment, the control panel 110 may be configured to generate and transmit an enabling signal to the smart door lock 182 subsequent to the transmission of the temporary passcode 280 to the smart door lock 182. The enabling signal enables the temporary passcode 280 such that the temporary passcode 280 can unlock the smart door lock 182. This configuration may be useful in cases where an authorization for enabling the temporary passcode 280 is required from the remote sever 190 (e.g., an authorization will be issued after the emergency event is verified by the human operator at the central control center). In an embodiment, the control panel 110 may be configured to send an enabling signal along with the temporary passcode 280 to the smart door lock 182 such that the temporary passcode 280 is enabled as soon as it is received by the smart door lock 182. In an embodiment, the smart door lock 182 is configured to enable the temporary passcode 280 on its own. In such a case, the control panel 110 may not send an enabling signal to the smart door lock 182 and the smart door lock 182 may enable the temporary passcode 280 as soon as it receives it.

The predefined period within which the smart door lock 182 is unlockable by the temporary passcode 280 may be for example ten minutes, twenty minutes, thirty minutes, one hour, two hours, three hours, or four hours. In cases where the temporary passcode 280 has not been used during the predefined period, the smart door lock 182 may be configured to disable the temporary passcode 280 upon expiry of the predefined period. Here, the passcode disablement allows the temporary passcode 280 to be removed from the smart door lock 182 (e.g., the memory of the smart door lock 182). In cases where the temporary passcode 280 has already been used (e.g., by an emergency rescue personnel), the smart door lock 182 may be configured to disable the temporary passcode 280. The timely disabling of the temporary passcode 280 may minimize the risk of the temporary passcode 280 being used by any unauthorized person and thus substantially maintains a high level of security of the premise.

In an embodiment, the safety and security system 100 may be further configured to verify whether the at least one emergency signal 270 (and thus the emergency event) is true or false. The emergency verification may be performed by the remote server 190 (e.g., the central control center) upon receiving a temporary passcode 280 and an emergency signal 270. For example, to verify whether the reported emergency event is true or false, a human operator at the central control center 190 may examine the existing image and optionally audio data received periodically from one or more image sensors (e.g., security cameras and image sensor 122 of the control panel) installed at the premise. Alternatively or in addition, the human operator may establish a live communication with the control panel 110 so as to view the premise live through the image sensors and where appropriate, to speak to a person at the premise.

Where the emergency verification reveals that the emergency event has not occurred (e.g., no fire or no burglary at the premise), the emergency signal 270 is then deemed to be a false signal. In an embodiment, the safety and security system 100 may be further configured to disable the temporary passcode 280. Where a false emergency is confirmed, the central control center 190 may generate and transmit a false emergency signal to the control panel 110. In the case where the temporary passcode 280 has already been enabled in the smart door lock 182 and the predefined enabling period has not expired, upon receiving the false emergency signal, the control panel 110 may generate and transmit a disabling signal to the smart door lock 182 so as to disable the temporary passcode 280. In the case where the temporary passcode 280 has been received by the smart door lock 182 but has not been enabled yet, upon receiving the false emergency signal, the control panel 110 may take no action (i.e. no enabling signal is transmitted to the smart door lock 182).

Where the emergency verification reveals that the emergency event has occurred, the emergency signal 270 is then deemed to be a true signal. In an embodiment, the central control center 190 may generate and transmit a true emergency signal to the control panel 110. In the case where the temporary passcode 280 has already been enabled in the smart door lock 182 and the predefined enabling period has not expired, upon receiving the true emergency signal, the control panel 110 may take no action. In the case where the temporary passcode 280 has been received by the smart door lock 182 but has not been enabled yet, upon receiving the true emergency signal which may act as an authorization signal, the control panel 110 may generate and transmit an enabling signal to the smart door lock so as to enable the temporary passcode 280.

In an embodiment, the safety and security system 100 may comprise one or more user devices 240 and be further configured to relay, by the remote server 190, the temporary passcode 280 and the emergency signal 270 to one or more user devices 240 via a data network. The user devices 240 may be held by emergency rescue personnel who may use the received temporary passcode 280 to unlock the smart door lock 182 and open the door 220 of the premise where the emergency event is detected. The user devices 240 may also be held by other authorized users. In an embodiment, the user devices 240 may comprise a dedicated application which allows the user (e.g., owner of the premise) to actively communicate with the safety and security system 100 (e.g., the remote server) so as to keep track of the emergency event and take prompt and necessary actions (e.g., providing information about the premise to the emergency rescue personnel, returning to the premise as soon as possible).

In an embodiment, the safety and security system 100 may be further configured to unlock remotely, by the remote server 190, the smart door 182 lock via a data network. In such a case, the smart door lock 182 may be configured to be directly communicable with the remote server via a data network (e.g., the Internet). In an example scenario, upon arrival of the emergency rescue personnel at the premise, the central control center 190 may be notified and may remotely open the smart door lock 182 using the temporary passcode 280 rather than transmitting the passcode 280 to the emergency rescue personnel. Such a configuration obviates the need for transmitting the temporary passcode 280 to any third party (e.g., emergency rescue personnel), thereby ensuring a high level of security of the premise even in emergencies.

Note that, the above description is for illustration only and other embodiments and variations may be envisaged without departing from the scope of the invention.

1. A safety and security system comprising:
a remote server communicatively coupleable to one or more user devices;
one or more emergency triggering mechanisms installed in [[the]] a premise for responding to emergency events;
a smart door lock for locking and unlocking a door of the premise, wherein the smart door lock is unlockable by inputting a passcode to the smart door lock; and
a control panel communicatively coupled to each of the one or more emergency triggering mechanisms, the smart door lock and the remote server;
wherein the safety and security system is configured to:
generate, by the one or more emergency triggering mechanisms, at least one emergency signal in response to an emergency event;
transmit, by the one or more emergency triggering mechanisms, the at least one emergency signal to the control panel;
generate, by the control panel, a temporary passcode to temporarily unlock the smart door lock so as to open the door of the premise upon receiving the at least one emergency signal from the one or more emergency triggering mechanisms;
transmit, by the control panel, the temporary passcode and the at least one emergency signal to the remote server such that the temporary passcode is obtainable by a human operator;
transmit, by the control panel, the temporary passcode to the smart door lock; and
enable, by the control panel or the smart door lock, the temporary passcode such that the smart door lock is unlockable by the temporary passcode in a predefined period of time.

2. A safety and security system as claimed in claim 1, wherein the one or more emergency triggering mechanisms comprise at least one emergency button each actuatable by a user in the premise in response to a medical emergency.

3. A safety and security system as claimed in claim 2, wherein in response to any of the at least one emergency button being actuated, the actuated emergency button is operable to generate and transmit the at least one emergency signal.

4. A safety and security system as claimed in claim 1, wherein the one or more emergency triggering mechanisms comprise at least one fire sensor each configured to generate and transmit the at least one emergency signal in response to a fire.

5. A safety and security system as claimed in claim 1, wherein the predefined period of time for the temporary passcode is less than 1 hour.

6. A safety and security system as claimed in claim 1, further configured to disable the temporary passcode upon expiry of the predefined period of time.

7. A safety and security system as claimed in claim 1, further configured to verify, by the remote server, whether the at least one emergency signal is true or false.

8. A safety and security system as claimed in claim 7, further configured to disable the temporary passcode when the at least one emergency signal is false.

9. A safety and security system as claimed in claim 1, further configured to unlock remotely, by the remote server, the smart door lock via a data network.

10. A safety and security system as claimed in claim 1, further comprising one or more user devices; wherein the safety and security system is configured to relay, by the remote server, the temporary passcode and the emergency signal to the one or more user devices via a data network.

11. A method of operating a safety and security system comprising:
a remote server communicatively coupleable to one or more user devices;
one or more emergency triggering mechanisms installed in a premise for responding to emergency events;
a smart door lock for locking and unlocking a door of the premise, wherein the smart door lock is unlockable by inputting a passcode the smart door lock;
and a control panel communicatively coupled to each of the one or more emergency triggering mechanisms, the smart door lock and the remote server;
the method comprising:
generating, by the one or more emergency triggering mechanisms, at least one emergency signal in response to an emergency event;
transmitting, by the one or more emergency triggering mechanisms, the at least one emergency signal to the control panel;
generating, by the control panel, a temporary passcode for temporarily unlocking the smart door lock so as to open the door of the premise upon receiving the at least one emergency signal from the one or more emergency triggering mechanisms;
transmitting, by the control panel, the temporary passcode and the at least one emergency signal to the remote server such that the temporary passcode is obtainable by a human operator;
transmitting, by the control panel, the temporary passcode to the smart door lock; and
enabling, by the control panel or the smart door lock, the temporary passcode such that the smart door lock is unlockable by the temporary passcode in a predefined period of time.

12. A method as claimed in claim 11, further comprising disabling, by the control panel or the smart door lock, the temporary passcode upon expiry of the predefined period of time.

13. A method as claimed in claim 11, further comprising verifying, by the remote server, whether the at least one emergency signal is true or false.

14. A method as claimed in claim 13, further comprising disabling, by the control panel or the smart door lock, the temporary passcode when the at least one emergency signal is false.

15. A method as claimed in claim 11, further comprising relaying, by the remote server, the temporary passcode and the emergency signal received from the control panel to one or more user devices via a data network.

16. A non-transitory computer-readable storage medium tangibly encoded with computer-executable instructions, that when executed by a processor, perform a method comprising:
a remote server communicatively coupleable to one or more user devices;
one or more emergency triggering mechanisms installed in a premise for responding to emergency events;
a smart door lock for locking and unlocking a door of the premise, wherein the smart door lock is unlockable by inputting a passcode the smart door lock;
and a control panel communicatively coupled to each of the one or more emergency triggering mechanisms, the smart door lock and the remote server;
the method comprising:
generating, by the one or more emergency triggering mechanisms, at least one emergency signal in response to an emergency event;
transmitting, by the one or more emergency triggering mechanisms, the at least one emergency signal to the control panel;
generating, by the control panel, a temporary passcode for temporarily unlocking the smart door lock so as to open the door of the premise upon receiving the at least one emergency signal from the one or more emergency triggering mechanisms;
transmitting, by the control panel, the temporary passcode and the at least one emergency signal to the remote server such that the temporary passcode is obtainable by a human operator;
transmitting, by the control panel, the temporary passcode to the smart door lock; and
enabling, by the control panel or the smart door lock, the temporary passcode such that the smart door lock is unlockable by the temporary passcode in a predefined period of time.

17. A non-transitory computer-readable storage medium as claimed in claim 16, further comprising disabling, by the control panel or the smart door lock, the temporary passcode upon expiry of the predefined period of time.

18. A non-transitory computer-readable storage medium as claimed in claim 16, further comprising verifying, by the remote server, whether the at least one emergency signal is true or false.

19. A non-transitory computer-readable storage medium as claimed in claim 18, further comprising disabling, by the control panel or the smart door lock, the temporary passcode when the at least one emergency signal is false.

20. A non-transitory computer-readable storage medium as claimed in any of claims 16, further comprising relaying, by the remote server, the temporary passcode and the emergency signal received from the control panel to one or more user devices via a data network
